(19) United States
(12) Patent Application Publication
(10) Pub. No.: US 2008/0240058 A1
(43) Pub. Date: Oct. 2, 2008

(54) SIMULTANEOUS WLAN COMMUNICATIONS TO CARRY PERSONAL AREA NETWORK COMMUNICATIONS

(75) Inventors: Christopher J. Hansen, Sunnyvale, CA (US); Raymond R. Hayes, Los Gatos, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 11/872,290

(22) Filed: Oct. 15, 2007

Related U.S. Application Data
(60) Provisional application No. 60/909,680, filed on Apr. 2, 2007.

(51) Int. Cl. H04Q 7/24

(52) U.S. Cl. 370/338

(57) ABSTRACT

An integrated circuit radio transceiver and associated method comprises a multi-mode device operable to support personal area network communications as well as traditional wireless local area network communications. In one embodiment, IEEE 802.11 protocol IBSS communications are used to transport Bluetooth communication data packets. In another embodiment, a direct link comprising direct packet transfers without beaconing is performed between the multi-mode device and another multi-mode device. Thus, the multi-mode device is operable to establish traditional BSS communications with an Access Point in addition to establishing peer-to-peer communications with another multi-mode device to transport the Bluetooth communications over the 802.11 IBSS communication link or over an IEEE 802.11 direct communication link.

### CROSS REFERENCE TO RELATED PATENTS

The present U.S. Utility patent application claims priority pursuant to 35 U.S.C. § 119(e) to the following U.S. Provisional Patent Application which is hereby incorporated herein by reference in its entirety and made part of the present U.S. Utility patent application for all purposes:
U.S. Provisional Application Ser. No. 60/909,680, entitled “SIMULTANEOUS WLAN COMMUNICATIONS TO CARRY PERSONAL AREA NETWORK COMMUNICATIONS”, filed Apr. 2, 2007.

### BACKGROUND

1. Technical Field

The present invention relates to wireless communications and, more particularly, to circuitry transmitting communications through multi-mode devices.

2. Related Art

Communication systems are known to support wireless and wire lined communications between wireless and/or wire lined communication devices. Such communication systems range from national and/or international cellular telephone systems to the Internet to point-to-point in-home wireless networks. Each type of communication system is constructed, and hence operates, in accordance with one or more communication standards. For instance, wireless communication systems may operate in accordance with one or more standards, including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, etc., communicates directly or indirectly with other wireless communication devices. For direct communications (also known as point-to-point communications), the participating wireless communication devices tune their receivers and transmitters to the same channel or channels (e.g., one of a plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via a public switch telephone network (PSTN), via the Internet, and/or via some other wide area network.

Each wireless communication device includes a built-in radio transceiver (i.e., receiver and transmitter) or is coupled to an associated radio transceiver (e.g., a station for in-home and/or in-building wireless communication networks, RF modem, etc.). As is known, the transmitter includes a data modulation stage, one or more intermediate frequency stages, and a power amplifier stage. The data modulation stage converts raw data into baseband signals in accordance with the particular wireless communication standard. The one or more intermediate frequency stages mix the baseband signals with one or more local oscillations to produce RF signals. The power amplifier stage amplifies the RF signals prior to transmission via an antenna.

Typically, the data modulation stage is implemented on a baseband processor chip, while the intermediate frequency (IF) stages and power amplifier stage are implemented on a separate radio processor chip. Historically, radio integrated circuits have been designed using bi-polar circuitry, allowing for large signal swings and linear transmitter component behavior. Therefore, many legacy baseband processors employ analog interfaces that communicate analog signals to and from the radio processor.

Personal area networks provide advantageous operations and are commonly used for very short distance communications. On occasion, however, there is a need to transport communication data from such personal area networks over a distance that is not readily supported by the personal area network.

### SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

A better understanding of the present invention can be obtained when the following detailed description of the preferred embodiment is considered with the following drawings, in which:

FIG. 1 is a functional block diagram illustrating a communication system that includes circuit devices and network elements and operation thereof according to one embodiment of the invention.

FIG. 2 is a schematic block diagram illustrating a wireless communication host device and an associated radio;

FIG. 3 is a schematic block diagram illustrating a wireless communication device that includes a host device and an associated radio;

FIGS. 4 and 5 illustrate communication networks with communication devices according to various embodiments of the invention;

FIG. 6 is a flow chart illustrating a method supporting multi-mode communications in a wireless multi-mode communication device;

FIG. 7 illustrates various OSI type stack layers of a multi-mode radio transceiver operable to carry Bluetooth communication under 802.11 protocols;

FIGS. 8 and 9 illustrate timing of a setting of IBSS beacons according to one embodiment of the invention;

FIG. 10 illustrates a method for multi-mode communications in a wireless local area network communication device;

FIG. 11 is a network diagram illustrating operation according to one embodiment of the invention;

FIG. 12 is a network diagram illustrating operation and systems according to one embodiment of the invention;

FIG. 13 is a timing diagram illustrating operation according to one embodiment of the invention; and

FIG. 14 is a method according to one embodiment of the invention.

### DETAILED DESCRIPTION OF THE DRAWINGS

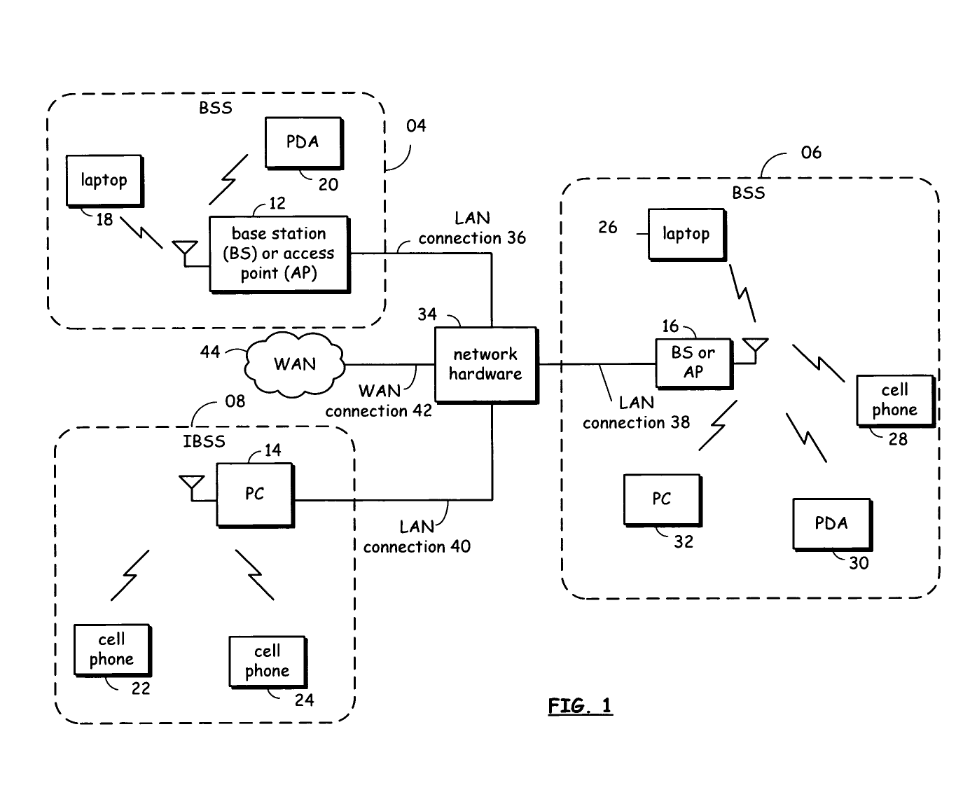

FIG. 1 is a functional block diagram illustrating a communication system that includes circuit devices and network elements and operation thereof according to one embodiment of the invention. More specifically, a plurality of network service areas 04, 06 and 08 are a part of a network 10. Network 10 includes a plurality of base stations or access points (APs) 12 and 16, a plurality of wireless communication devices 18-32 and a network hardware component 34. The wireless communication devices 18-32 may be laptop computers 18 and 26, personal digital assistants 20 and 30, personal computers 14 and 32 and/or cellular telephones 22, 24 and 28. The details of the wireless communication devices will be described in greater detail with reference to the Figures that follow.

The base stations or APs 12-16 are operably coupled to the network hardware component 34 via local area network (LAN) connections 36, 38 and 40. The network hardware component 34, which may be a router, switch, bridge, modem, system controller, etc., provides a wide area network (WAN) connection 42 for the communication system 10 to an external network element such as WAN 44. Each of the base stations or access points 12-16 has an associated antenna or antenna array to communicate with the wireless communication devices in its area. Typically, the wireless communication devices 18-32 register with the particular base station or access points 12-16 to receive services from the communication system 10. For direct connections (i.e., point-to-point communications), wireless communication devices communicate directly via an allocated channel.

Typically, base stations are used for cellular telephone systems and like-type systems, while access points are used for in-home or in-building wireless networks. Regardless of the particular type of communication system, each wireless communication device includes a built-in radio and/or is coupled to a radio.

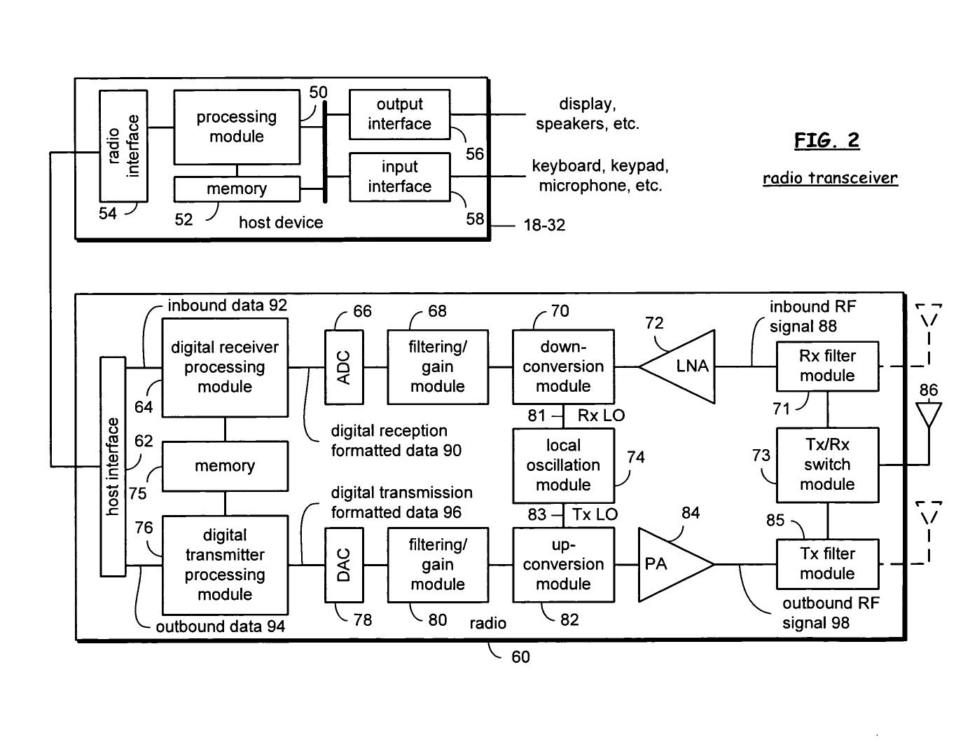

FIG. 2 is a schematic block diagram illustrating a wireless communication host device 18-32 and an associated radio 60. For cellular telephone hosts, radio 60 is a built-in component. For personal digital assistants hosts, laptop hosts, and/or personal computer hosts, the radio 60 may be built-in or an externally coupled component.

As illustrated, wireless communication host device 18-32 includes a processing module 50, a memory 52, a radio interface 54, an input interface 58 and an output interface 56. Processing module 50 and memory 52 execute the corresponding instructions that are typically done by the host device. For example, for a cellular telephone host device, processing module 50 performs the corresponding communication functions in accordance with a particular cellular telephone standard.

Radio interface 54 allows data to be received from and sent to radio 60. For data received from radio 60 (e.g., inbound data), radio interface 54 provides the data to processing module 50 for further processing and/or routing to output interface 56. Output interface 56 provides connectivity to an output device such as a display, monitor, speakers, etc., such that the received data may be displayed. Radio interface 54 also provides data from processing module 50 to radio 60. Processing module 50 may receive the outbound data from an input device such as a keyboard, keypad, microphone, etc., via input interface 58 or generate the data itself. For data received via input interface 58, processing module 50 may perform a corresponding host function on the data and/or route it to radio 60 via radio interface 54.

Radio 60 includes a host interface 62, a digital receiver processing module 64, an analog-to-digital converter 66, a filtering/gain module 68, a down-conversion module 70, a low noise amplifier 72, a receiver filter module 71, a transmitter/receiver (Tx/Rx) switch module 73, a local oscillation module 74, a memory 75, a digital transmitter processing module 76, a digital-to-analog converter 78, a filtering/gain module 80, an up-conversion module 82, a power amplifier 84, a transmitter filter module 85, and an antenna 86 operatively coupled as shown. The antenna 86 is shared by the transmit and receive paths as regulated by the Tx/Rx switch module 73. The antenna implementation will depend on the particular standard to which the wireless communication device is compliant.

Digital receiver processing module 64 and digital transmitter processing module 76, in combination with operational instructions stored in memory 75, execute digital receiver functions and digital transmitter functions, respectively. The digital receiver functions include, but are not limited to, demodulation, constellation demapping, decoding, and/or descrambling. The digital transmitter functions include, but are not limited to, scrambling, encoding, constellation mapping, and modulation. Digital receiver and transmitter processing modules 64 and 76, respectively, may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Memory 75 may be a single memory device or a plurality of memory devices. Such a memory device may be a read-only memory, random access memory, volatile memory, non-volatile memory, static memory, dynamic memory, flash memory, and/or any device that stores digital information. Note that when digital receiver processing module 64 and/or digital transmitter processing module 76 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. Memory 75 stores, and digital receiver processing module 64 and/or digital transmitter processing module 76 executes, operational instructions corresponding to at least some of the functions illustrated herein.

In operation, radio 60 receives outbound data 94 from wireless communication host device 18-32 via host interface 62. Host interface 62 routes outbound data 94 to digital transmitter processing module 76, which processes outbound data 94 in accordance with a particular wireless communication standard or protocol (e.g., IEEE 802.11(a), IEEE 802.11b, Bluetooth, etc.) to produce digital transmission formatted data 96. Digital transmission formatted data 96 will be a digital baseband signal or a digital low IF signal, where the low IF typically will be in the frequency range of one hundred kilohertz to a few megahertz.

Digital-to-analog converter 78 converts digital transmission formatted data 96 from the digital domain to the analog domain. Filtering/gain module 80 filters and/or adjusts the gain of the analog baseband signal prior to providing it to up-conversion module 82. Up-conversion module 82 directly converts the analog baseband signal, or low IF signal, into an RF signal based on a transmitter local oscillation 83 provided by local oscillation module 74. Power amplifier 84 amplifies the RF signal to produce an outbound RF signal 98, which is filtered by transmitter filter module 85. The antenna 86 transmits outbound RF signal 98 to a targeted device such as a base station, an access point and/or another wireless communication device.

Radio 60 also receives an inbound RF signal 88 via antenna 86, which was transmitted by a base station, an access point, or another wireless communication device. The antenna 86 provides inbound RF signal 88 to receiver filter module 71 via Tx/Rx switch module 73, where Rx filter module 71 bandpass filters inbound RF signal 88. The Rx filter module 71 provides the filtered RF signal to low noise amplifier 72, which amplifies inbound RF signal 88 to produce an amplified inbound RF signal. Low noise amplifier 72 provides the amplified inbound RF signal to down-conversion module 70, which directly converts the amplified inbound RF signal into an inbound low IF signal or baseband signal based on a receiver local oscillation 81 provided by local oscillation module 74. Down-conversion module 70 provides the inbound low IF signal or baseband signal to filtering/gain module 68. Filtering/gain module 68 may be implemented in accordance with the teachings of the present invention to filter and/or attenuate the inbound low IF signal or the inbound baseband signal to produce a filtered inbound signal.

Analog-to-digital converter 66 converts the filtered inbound signal from the analog domain to the digital domain to produce digital reception formatted data 90. Digital receiver processing module 64 decodes, descrambles, demaps, and/or demodulates digital reception formatted data 90 to recapture inbound data 92 in accordance with the particular wireless communication standard being implemented by radio 60. Host interface 62 provides the recaptured inbound data 92 to the wireless communication host device 18-32 via radio interface 54.

As one of average skill in the art will appreciate, the wireless communication device of FIG. 2 may be implemented using one or more integrated circuits. For example, the host device may be implemented on a first integrated circuit, while digital receiver processing module 64, digital transmitter processing module 76 and memory 75 may be implemented on a second integrated circuit, and the remaining components of radio 60, less antenna 86, may be implemented on a third integrated circuit. As an alternate example, radio 60 may be implemented on a single integrated circuit. As yet another example, processing module 50 of the host device and digital receiver processing module 64 and digital transmitter processing module 76 may be a common processing device implemented on a single integrated circuit.

Memory 52 and memory 75 may be implemented on a single integrated circuit and/or on the same integrated circuit as the common processing modules of processing module 50, digital receiver processing module 64, and digital transmitter processing module 76. As will be described, it is important that accurate oscillation signals are provided to mixers and conversion modules. A source of oscillation error is noise coupled into oscillation circuitry through integrated circuitry biasing circuitry. One embodiment of the present invention reduces the noise by providing a selectable pole low pass filter in current mirror devices formed within the one or more integrated circuits.

Local oscillation module 74 includes circuitry for adjusting an output frequency of a local oscillation signal provided therefrom. Local oscillation module 74 receives a frequency correction input that it uses to adjust an output local oscillation signal to produce a frequency corrected local oscillation signal output. While local oscillation module 74, up-conversion module 82 and down-conversion module 70 are implemented to perform direct conversion between baseband and RF, it is understood that the principles herein may also be applied readily to systems that implement an intermediate frequency conversion step at a low intermediate frequency.

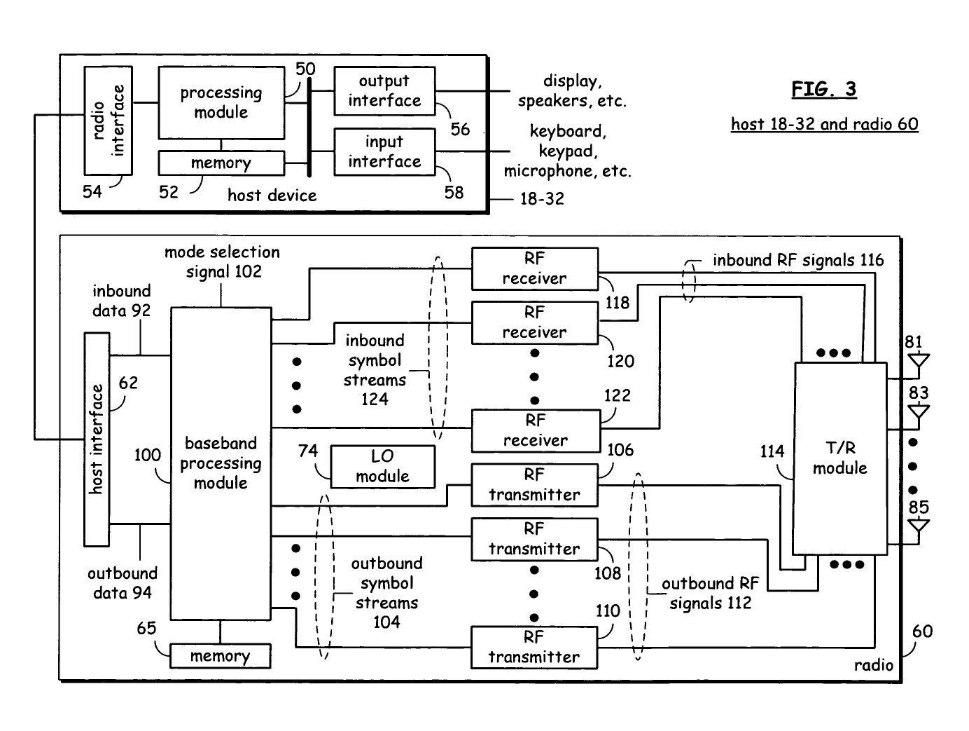

FIG. 3 is a schematic block diagram illustrating a wireless communication device that includes the host device 18-32 and an associated radio 60. For cellular telephone hosts, the radio 60 is a built-in component. For personal digital assistants hosts, laptop hosts, and/or personal computer hosts, the radio 60 may be built-in or an externally coupled component.

As illustrated, the host device 18-32 includes a processing module 50, memory 52, radio interface 54, input interface 58 and output interface 56. The processing module 50 and memory 52 execute the corresponding instructions that are typically done by the host device. For example, for a cellular telephone host device, the processing module 50 performs the corresponding communication functions in accordance with a particular cellular telephone standard.

The radio interface 54 allows data to be received from and sent to the radio 60. For data received from the radio 60 (e.g., inbound data), the radio interface 54 provides the data to the processing module 50 for further processing and/or routing to the output interface 56. The output interface 56 provides connectivity to an output display device such as a display, monitor, speakers, etc., such that the received data may be displayed. The radio interface 54 also provides data from the processing module 50 to the radio 60. The processing module 50 may receive the outbound data from an input device such as a keyboard, keypad, microphone, etc., via the input interface 58 or generate the data itself. For data received via the input interface 58, the processing module 50 may perform a corresponding host function on the data and/or route it to the radio 60 via the radio interface 54.

Radio 60 includes a host interface 62, a baseband processing module 100, memory 65, a plurality of radio frequency (RF) transmitters 106-110, a transmit/receive (T/R) module 114, a plurality of antennas 81-85, a plurality of RF receivers 118-120, and a local oscillation module 74. The baseband processing module 100, in combination with operational instructions stored in memory 65, executes digital receiver functions and digital transmitter functions, respectively. The digital receiver functions include, but are not limited to, digital intermediate frequency to baseband conversion, demodulation, constellation demapping, decoding, de-interleaving, fast Fourier transform, cyclic prefix removal, space and time decoding, and/or descrambling. The digital transmitter functions include, but are not limited to, scrambling, encoding, interleaving, constellation mapping, modulation, inverse fast Fourier transform, cyclic prefix addition, space and time encoding, and digital baseband to IF conversion. The baseband processing module 100 may be implemented using one or more processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory 65 may be a single memory device or a plurality of memory devices. Such a memory device may be a read-only memory, random access memory, volatile memory, non-volatile memory, static memory, dynamic memory, flash memory, and/or any device that stores digital information. Note that when the baseband processing module 100 implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

In operation, the radio 60 receives outbound data 94 from the host device via the host interface 62. The baseband processing module 100 receives the outbound data 94 and, based on a mode selection signal 102, produces one or more outbound symbol streams 104. The mode selection signal 102 will indicate a particular mode of operation that is compliant with one or more specific modes of the various IEEE 802.11 standards. For example, the mode selection signal 102 may indicate a frequency band of 2.4 GHz, a channel bandwidth of 20 or 22 MHz and a maximum bit rate of 54 megabits-per-second. In this general category, the mode selection signal will further indicate a particular rate ranging from 1 megabit-per-second to 54 megabits-per-second. In addition, the mode selection signal will indicate a particular type of modulation, which includes, but is not limited to, Barker Code Modulation, BPSK, QPSK, CCK, 16 QAM and/or 64 QAM. The mode selection signal 102 may also include a code rate, a number of coded bits per subcarrier (NBPSC), coded bits per OFDM symbol (NCBPS), and/or data bits per OFDM symbol (NDBPS). The mode selection signal 102 may also indicate a particular channelization for the corresponding mode that provides a channel number and corresponding center frequency. The mode selection signal 102 may further indicate a power spectral density mask value and a number of antennas to be initially used for a MIMO communication.

The baseband processing module 100, based on the mode selection signal 102 produces one or more outbound symbol streams 104 from the outbound data 94. For example, if the mode selection signal 102 indicates that a single transmit antenna is being utilized for the particular mode that has been selected, the baseband processing module 100 will produce a single outbound symbol stream 104. Alternatively, if the mode selection signal 102 indicates 2, 3 or 4 antennas, the baseband processing module 100 will produce 2, 3 or 4 outbound symbol streams 104 from the outbound data 94.

Depending on the number of outbound symbol streams 104 produced by the baseband processing module 100, a corresponding number of the RF transmitters 106-110 will be enabled to convert the outbound symbol streams 104 into outbound RF signals 112. In general, each of the RF transmitters 106-110 includes a digital filter and upsampling module, a digital-to-analog conversion module, an analog filter module, a frequency up conversion module, a power amplifier, and a radio frequency bandpass filter. The RF transmitters 106-110 provide the outbound RF signals 112 to the transmit/receive module 114, which provides each outbound RF signal to a corresponding antenna 81-85.

When the radio 60 is in the receive mode, the transmit/receive module 114 receives one or more inbound RF signals 116 via the antennas 81-85 and provides them to one or more RF receivers 118-122. The RF receiver 118-122 converts the inbound RF signals 116 into a corresponding number of inbound symbol streams 124. The number of inbound symbol streams 124 will correspond to the particular mode in which the data was received. The baseband processing module 100 converts the inbound symbol streams 124 into inbound data 92, which is provided to the host device 18-32 via the host interface 62.

As one of average skill in the art will appreciate, the wireless communication device of FIG. 3 may be implemented using one or more integrated circuits. For example, the host device may be implemented on a first integrated circuit, the baseband processing module 100 and memory 65 may be implemented on a second integrated circuit, and the remaining components of the radio 60, less the antennas 81-85, may be implemented on a third integrated circuit. As an alternate example, the radio 60 may be implemented on a single integrated circuit. As yet another example, the processing module 50 of the host device and the baseband processing module 100 may be a common processing device implemented on a single integrated circuit. Further, the memory 52 and memory 65 may be implemented on a single integrated circuit and/or on the same integrated circuit as the common processing modules of processing module 50 and the baseband processing module 100.

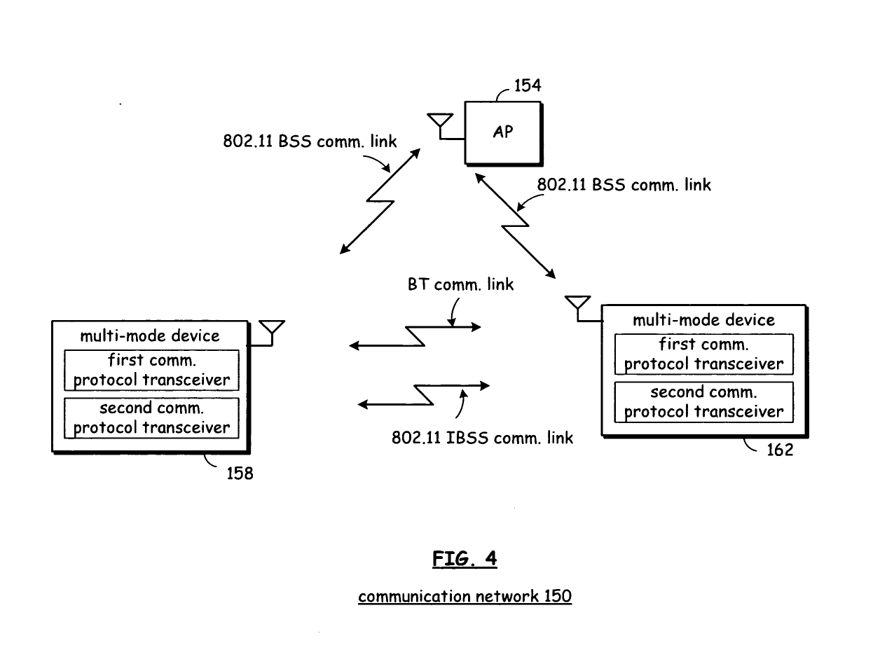

FIG. 4 is a functional block diagram of a communication network according to one embodiment of the present invention. A communication network 150 includes an access point 154 operable to generate beacons to control wireless local area network communications with compatible communication devices in a hub-and-spoke configuration of a first communication network that operates according to a first communication network protocol. In the described embodiment, the communications controlled by access point 150 are BSS communications as defined by IEEE 802.11 communications protocols. Network 150 further includes a first multi-mode communication device 158 operable to support communications with the access point 154 according to the first communication network protocol and further operable to concurrently support peer-to-peer communications with other multi-mode communication devices such as device 162.

Second multi-mode communication device 162 is operable to support communications with the access point 154 according to the first communication network protocol and is further operable to concurrently support peer-to-peer communications with other multi-mode communication devices such as device 162. The peer-to-peer communications may be IEEE 802.11 IBSS communications as well as Bluetooth Master/Slave communications.

The first and second multi-mode communication devices 158 and 162 are thus operable to communicate in a peer-to-peer configuration with each other while also supporting communications with the access point. More specifically, the first and second multi-mode communication devices 158 and 162 are operable to communicate over the peer-to-peer network using the first communication network protocol (the IBSS communications) and are further operable to carry communications of a second communication network communication (Bluetooth) using the peer-to-peer configuration using the first communication network protocol.

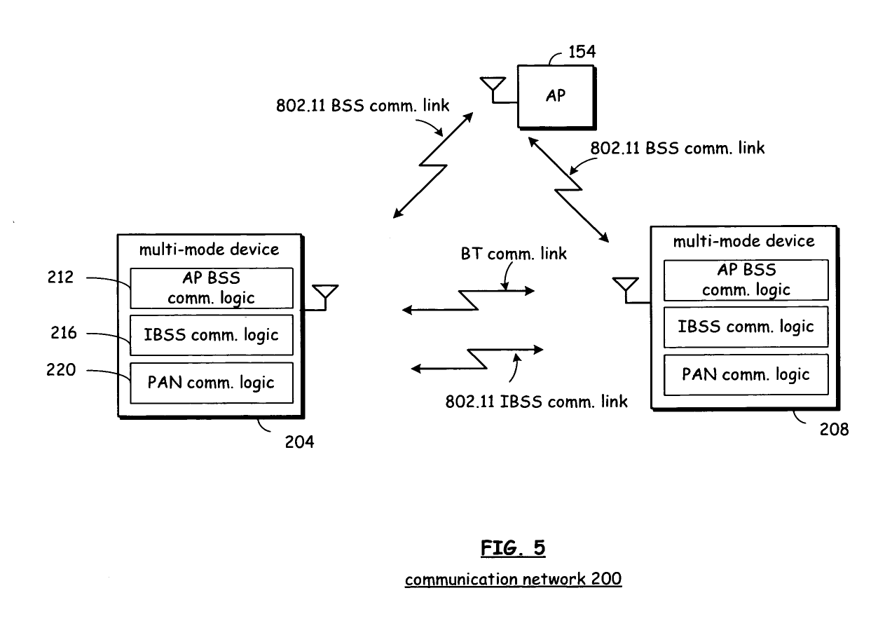

FIG. 5 is a functional block diagram of a communication network according to one embodiment of the invention. A multi-mode communication device 204 is operable to communication with access point 154 and with device 208. Device 204 includes a first communication logic 212 operable to support communications with an access point according to a first communication network protocol (802.11 in the described embodiment). Device 204 further includes a second communication logic 216 operable to support peer-to-peer communications with other multi-mode communication devices according to the first communication network protocol at the same time the first communication logic operably supports communications with the access point 154. First and second multi-mode communication devices 204 and 208 are further operable to communicate in a peer-to-peer configuration with each other while also supporting communications with the access point.

The multi-mode communication device 204 further included a third communication logic 220 operable to support peer-to-peer communications with other multi-mode communication devices according to a second communication protocol (Bluetooth in the described embodiment) while at least one of the first and second communication logics are operable to support their respective communications.

The second communication protocol, namely Bluetooth, is a known personal area network protocol. Whether the second protocol is Bluetooth or another personal area network communication protocol, the protocol is a peer-to-peer communication protocol. For Bluetooth protocol communications, the first and second communication logics are operable to support master-slave communications according to the second communication protocol by transporting communication signals of the second communication protocol.

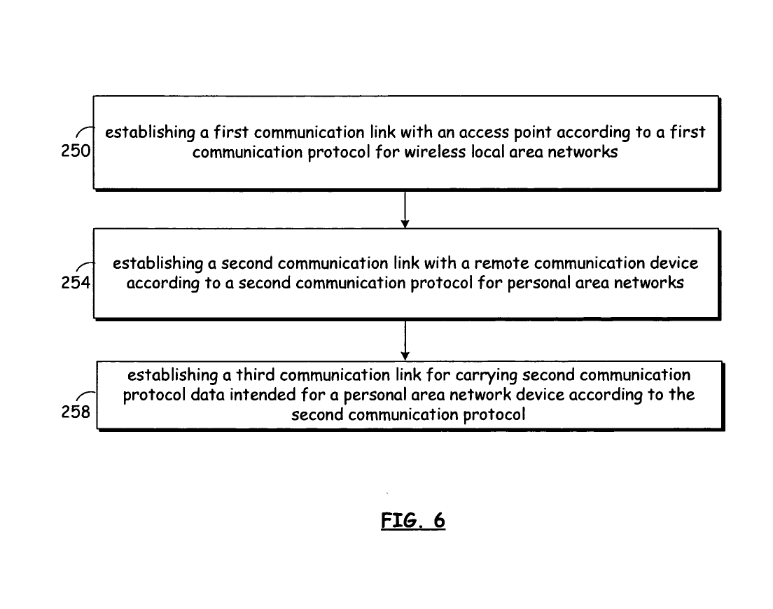

FIG. 6 is a flow chart illustrating a method supporting multi-mode communications in a wireless multi-mode communication device. Specifically, the method includes establishing a first communication link with an access point according to a first communication protocol for wireless local area networks (step 250). The method further includes establishing a second communication link with a remote communication device wherein the second communication link is a peer-to-peer communication link according to the first communication protocol (step 254). Finally, the method includes establishing a third communication link for carrying second communication protocol data intended for a personal area network device according to the second communication protocol (step 258). The third communication link is a peer-to-peer communication according to the second communication protocol. The first communication link is a BSS communication link as defined by 802.11 standard communication protocol standards. The second communication link is an IBSS communication link as defined by 802.11 standard communication protocol standards. The communication device performing the method of FIG. 6 is thus operable to carry communications from the third communication link according to the second communication protocol on the second communication link according to the first communication protocol.

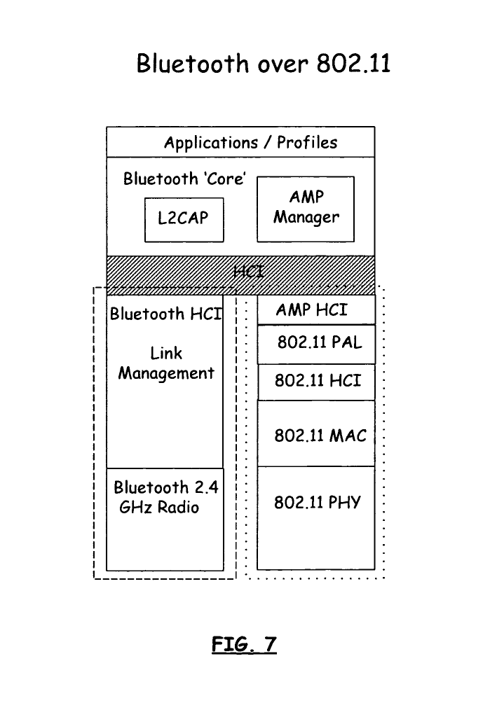

FIG. 7 illustrates various OSI type stack layers of a multi-mode radio transceiver operable to carry Bluetooth communication under 802.11 protocols.

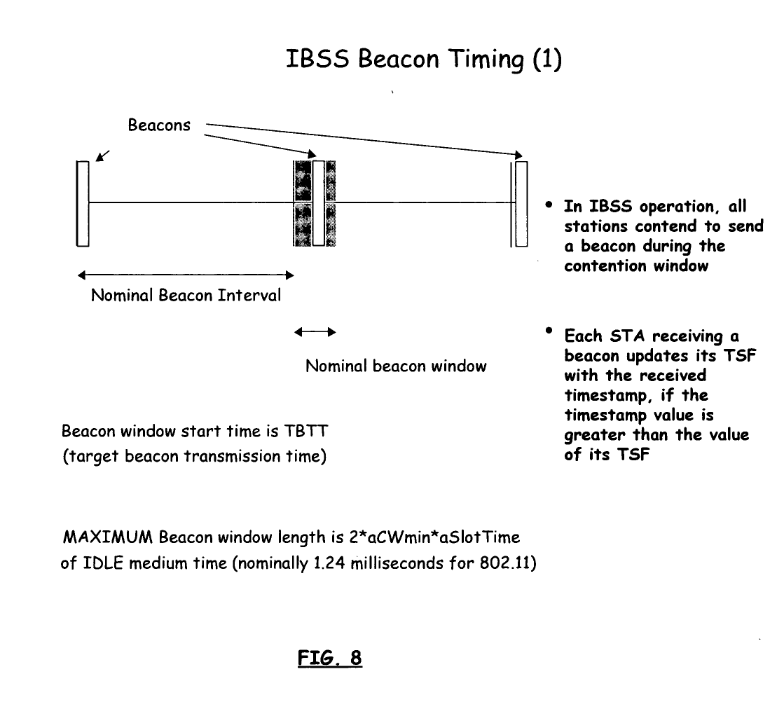

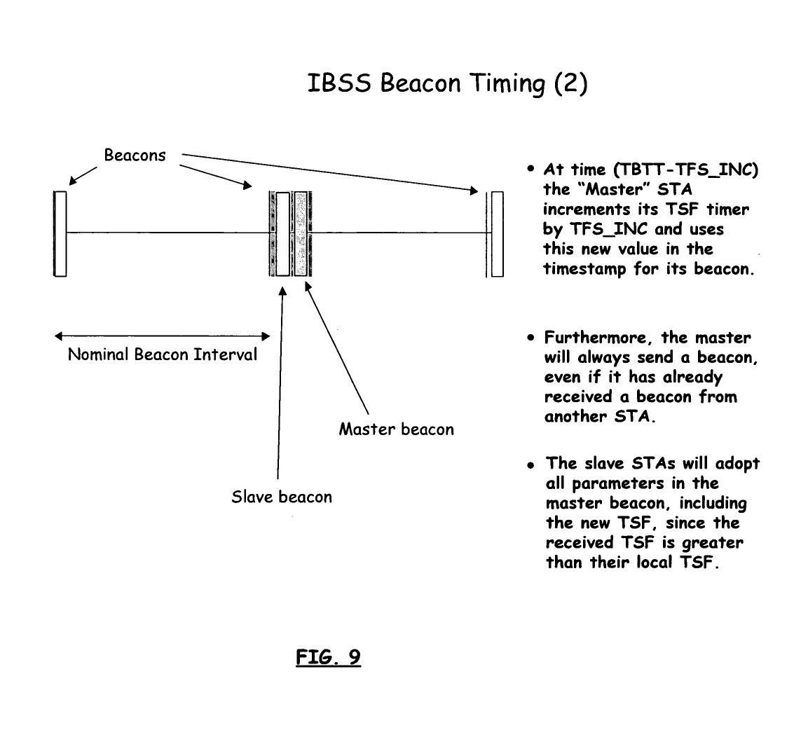

FIGS. 8 and 9 jointly illustrate timing of the setting of IBSS beacons according to one embodiment of the invention. Specifically, a terminal that determines to operate as a “master” of a peer-to-peer IBSS communication link, advances its TSF timer to prevent transmission settings from being reset by other multi-mode devices.

The first and second multi-mode communication devices are thus operable to communicate in a peer-to-peer configuration using the first communication network protocol including operating according to protocol for a TSF Timer while also communicating with the access point using the first communication network protocol. Specifically, each of the first and second multi-mode communication devices is operable to determine that it should act as a master of the peer-to-peer configuration and, based upon determining to act as a master, to advance a value of its TSF Timer. The first and second multi-mode communication devices are further operable to send a beacon on a periodic basis based upon the advanced TSF timer value and to compare a time stamp value in a received beacon and to compare the received time stamp value to its TSF timer value. The first and second multi-mode communication devices determine to not send out a beacon based upon the comparison of the time stamp value in a received beacon and to its TSF timer value if the time stamp value is greater than its TSF timer value. Alternatively, the first and second multi-mode communication devices are operable to determine to send out a beacon based upon the comparison of the time stamp value in a received beacon and to its TSF timer value if the time stamp value is less than its TSF timer value.

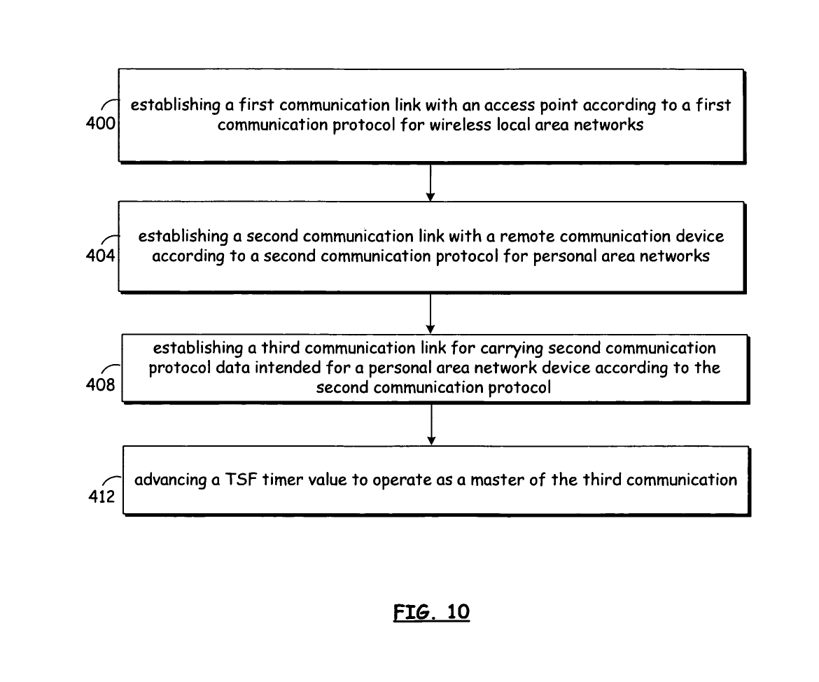

FIG. 10 is a method for multi-mode communications in a wireless local area network communication device. The method comprises establishing a first communication link with an access point according to a first communication protocol for wireless local area networks (step 400), establishing a second communication link with a remote communication device according to a second communication protocol for personal area networks (step 404), establishing a third communication link for carrying second communication protocol data intended for a personal area network device according to the first communication protocol (step 408) and advancing a TSF timer value to operate as a master of the third communication (step 412).

The third communication is a peer-to-peer communication according to the first communication protocol. In one embodiment, the third communication is an IBSS communication link as defined by 802.11 standard communication protocol standards.

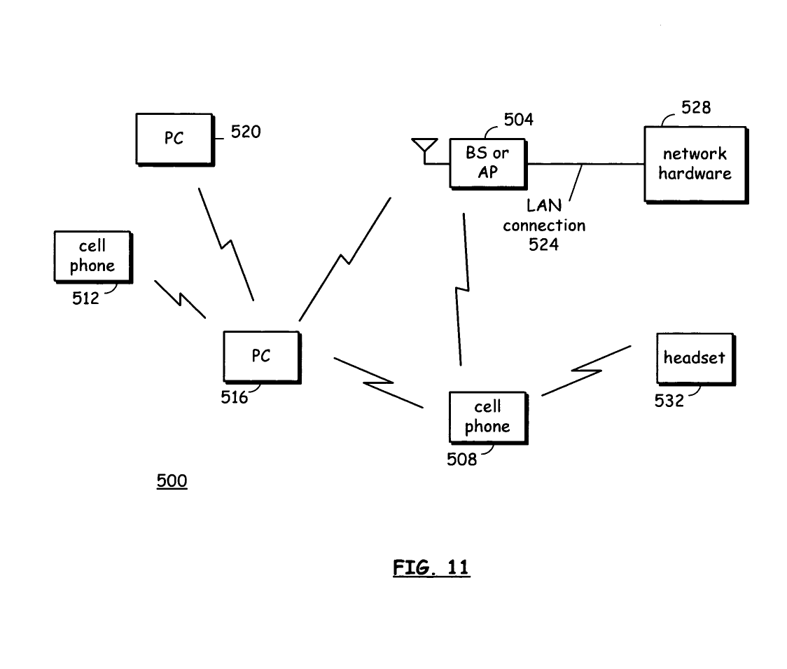

FIG. 11 is a communication network comprising an access point and first and second multi-mode communication devices, all operating according to at least according to one embodiment of the invention. The network 500 includes access point 504 which is operable to generate beacons to control wireless local area network communications with compatible communication devices in a hub-and-spoke configuration of a first communication network that operates according to a first communication network protocol. The first communication network protocol, in one embodiment, is one of the IEEE 802.11 wireless local area network protocols. The first multi-mode communication device and the second multi-mode communication device can be any one of cell phones 508-512 or personal computers 516-520, respectively. As may further be seen, access point 504 is communicatively coupled by way of local area connection 524 to network hardware 528 for electronic access to the Internet or other communication networks. Any one of the cell phones 508-512 or personal computers 516-520 may further communicate with each other using a direct link (with no beacon). Thus, if a cell phone is operable as a first communication device to communicate directly with another cell phone or a personal computer as a second communication device without using a beacon to synchronize communications and without establishing a link through the access point 504 and without requiring synchronization control by the access point.

Each of the communication devices 508-520 is operable to support communications with access point 504 according to the first communication network protocol and further operable to concurrently support direct packet transfers with other multi-mode communication devices using a second communication protocol. In the described embodiments, the second communication protocol is a personal area network protocol (e.g., Bluetooth). Moreover, the communication devices of FIG. 11 are further operable to support direct link communications using the first communication protocol with each other either in place using the second protocol communication. As an additional aspect, the first and second multi-mode communication devices are operable to encapsulate and carry second protocol communications data using the direct link first communication protocol. Finally, devices 508-520 are further operable to support a personal area network communication protocol (such as Bluetooth) with personal area network devices such as headset 532. Thus, cell phone 508 is operable, for example, to support 802.11 BSS communications with access point 504, direct link communications with PC 516, and Bluetooth communications with PC 516 as well as with headset 532.

In operation, the first and second multi-mode communication devices operable to support communications with the access point according to the first communication network protocol and further operable to concurrently support communications with other multi-mode communication devices using the second communication protocol. The first and second multi-mode communication devices are further operable to support direct packet transfers between each other while also supporting communications with the access point. The direct packet transfers in one embodiment are according to the first communication protocol. The direct packet transfers specifically include data of the second protocol communications encapsulated therein.

In an alternate embodiment, the data of the second protocol communications is encapsulated according to a third communication protocol. One aspect for each embodiment, however, is that second protocol communications are initially used to establish communication device capabilities prior to switching from the second protocol communications to the first or third protocol communications. Further, control signaling for the switch to the first or third protocol communications including establishing and/or generating encryption parameters for secure communications is generated using the second protocol.

In the embodiments in which the first and second multi-mode communication devices switch from the second to the first communication protocol for communications there between, the communication devices are operable to transmit packets directly to each other without using a beacon to carry communications of a second communication network protocol using the first communication network protocol. Accordingly, the first and second multi-mode communication devices are operable to engage in 802.11 protocol BSS communications with the access point 504, for example, while engaging in 802.11 direct link communications with each other.

Additionally, the first and second multi-mode communication devices are operable to support master-slave communications of a second communication network that operates according to a second communication network protocol while communicating with the access point according to the first communication network protocol. One aspect of these direct link communications is that they may be used to convey encapsulated second communication protocol communications after switching from the second to the first (or third) communication protocol.

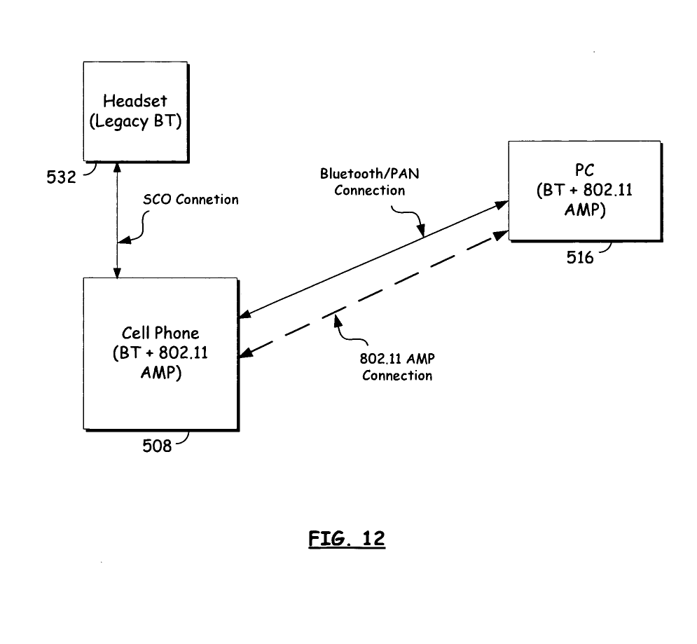

FIG. 12 is a network diagram illustrating operation and systems according to one embodiment of the invention. In one exemplary application, a mobile handset is operable to establish an audio connection using the second protocol with, for example, a headset while also establishing a data communication link with a server such as a personal computer or desktop. One problem, however, is that overlapping communications on these two links cause interference with each other. While the mobile handset is operable to avoid the conflicts since it is involved in both communication links, the server and the headset (in this example) are not readily able to determine when they can communicate with the mobile handset to avoid interfering with the other communication link. Thus, if the remote terminal (either the server or the headset) is wishing to send data, it is operable to send an RTS frame (Request to Send) to which the mobile handset is operable to reply with a CTS frame (Clear To Send). Typically, the CTS frame is transmitted to include a defined a wait period in one embodiment.

In this particular example, the audio connection may comprise a Bluetooth (BT) synchronized connection oriented protocol (SCO) for supporting the audio transmission from the mobile handset to the wireless headset. Aside from SCO, Bluetooth audio profile is the advanced audio distribution profile (A2DP profile) for high-fidelity stereo audio for media player applications, smart phones with MP3 capabilities, etc. One mandatory codec is required to be supported in the A2DP profile. The bit-rate corresponding to the high quality codec parameter settings of the codec is 345 kbps. Some media player companies prefer to use larger bitpool values than recommended in the A2DP specification for high quality, which translates into even higher than 345 kbps bit rates. This audio data is transmitted over Bluetooth's ACL link (i.e. asynchronous link, unlike SCO).

In spite of the asynchronous nature of this link, when it is used to carry A2DP data, this data needs to be transmitted within typically 50-80 ms, else it will be discarded due to the remote headset's ability to only buffer a specified amount of data (around 50-80 ms of data at most for current devices). The BT frame duration for A2DP ACL packets is typically 3.75 ms. The spacing between BT frames is arbitrary, in that ACL packets are transmitted as soon as enough audio payload becomes available to fill up a 5-slot Bluetooth packet for transmission from the cell phone to the headset. The high bit rate requirements relative to the available bandwidth on a Bluetooth connection means the medium usage can be fairly high.

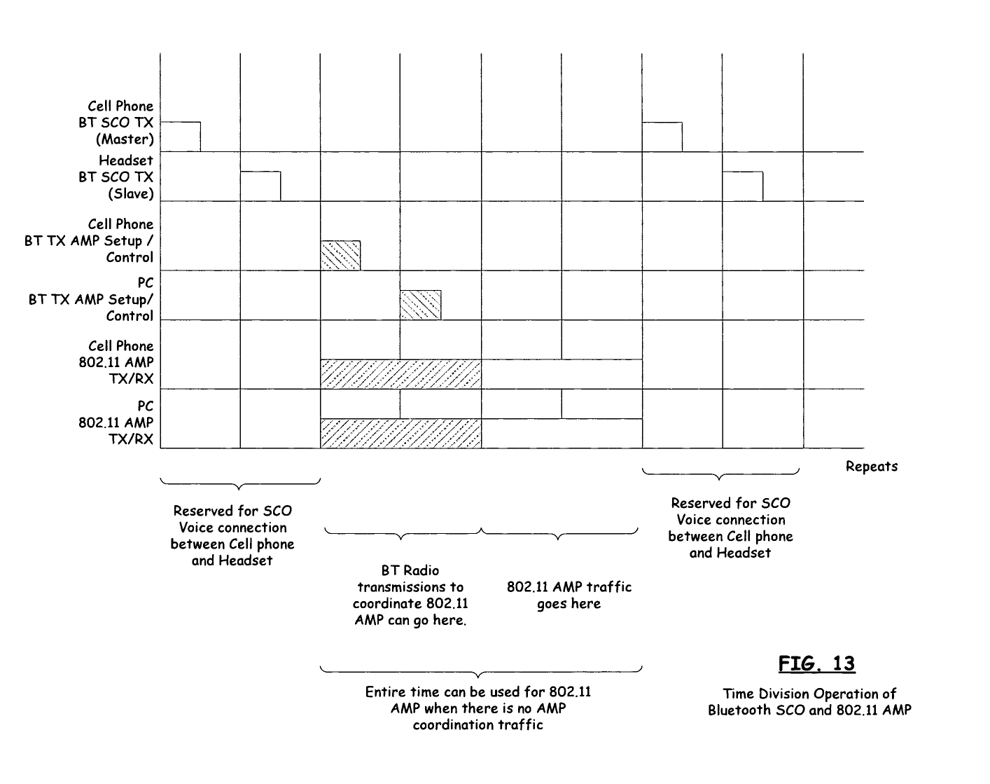

FIG. 13 is a timing diagram illustrating operation according to one embodiment of the invention and illustrates exemplary operation. More particularly, FIG. 13 may be viewed in relation to the discussion of FIG. 12. In general terms, FIG. 13 illustrates that a plurality of periods are defined for SCO communications and 802.11 AMP communications (including 802.11 AMP traffic and Bluetooth communications to coordinate the 802.11 AMP traffic). One aspect, however, is that the cell phone acts as a controller to coordinate the timing of FIG. 13 (or similar timing schemes) using the aforementioned RTS/CTS scheme. Accordingly, a beacon is not required for 802.11 AMP communications between the cell phone and the PC in the example of FIG. 20.

In operation, a user of cell phone 508 is thus operable to, for example, select some streaming hi-fidelity audio stored on PC 516. The audio which is subsequently streamed by PC 516 can collide or overrun communications between cell phone 508 and headset 532. Accordingly, using RTS/CTS for communication control, cell phone 508 is operable to control transmission timing to avoid conflict, collisions, or interference as well as overrun of headset 532 capabilities. Thus, cell phone 508 utilizes RTS/CTS communication control to achieve communication timing as shown in FIG. 13.

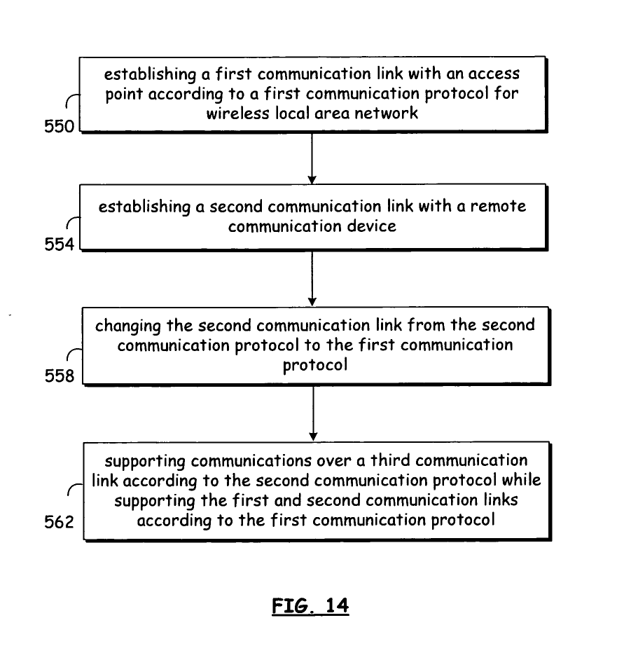

FIG. 14 is a flow chart that illustrates a method in a mobile handset according to one embodiment of the invention for controlling transmissions to and from a remote device using a personal area network protocol and further controlling transmissions to and from a server (either directly or through the Internet) to reduce conflict, interference or collisions with each others transmissions. A first step of the method for supporting multi-mode communications in a wireless multi-mode communication device includes establishing a first communication link with an access point according to a first communication protocol for wireless local area network (step 550).

Thereafter, the method includes establishing a second communication link with a remote communication device (step 554) wherein the second communication link is a peer-to-peer communication link according to a second communication protocol for carrying second communication protocol data intended for a personal area network device according to the second communication protocol. The method further includes subsequently changing the second communication link from the second communication protocol to the first communication protocol (step 558) wherein the second communication protocol data is encapsulated and transmitted in a direct link according to the first communication protocol.

The first communication link is a BSS communication link as defined by 802.11 standard communication protocol standards. The second communication link according to the first communication protocol after changing from the second communication protocol is a direct communication link without beaconing. The method further includes the communication device supporting communications over a third communication link according to the second communication protocol while supporting the first and second communication links according to the first communication protocol (step 562).

As one of ordinary skill in the art will appreciate, the term “substantially” or “approximately”, as may be used herein, provides an industry-accepted tolerance to its corresponding term and/or relativity between items. Such an industry-accepted tolerance ranges from less than one percent to twenty percent and corresponds to, but is not limited to, component values, integrated circuit process variations, temperature variations, rise and fall times, and/or thermal noise. Such relativity between items ranges from a difference of a few percent to magnitude differences.

As one of ordinary skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled”.

While the invention is susceptible to various modifications and alternative forms, specific embodiments thereof have been shown by way of example in the drawings and detailed description. It should be understood, however, that the drawings and detailed description thereto are not intended to limit the invention to the particular form disclosed, but, on the contrary, the invention is to cover all modifications, equivalents and alternatives falling within the spirit and scope of the present invention as defined by the claims. As may be seen, the described embodiments may be modified in many different ways without departing from the scope or teachings of the invention.

1. A communication network, comprising:
an access point operable to generate beacons to control wireless local area network communications with compatible communication devices in a hub-and-spoke configuration of a first communication network that operates according to a first communication network protocol;
a first multi-mode communication device operable to support communications with the access point according to the first communication network protocol and further operable to concurrently support communications with other multi-mode communication devices using a second communication protocol;
a second multi-mode communication device operable to support communications with the access point according to the first communication network protocol and further operable to concurrently support communications with other multi-mode communication devices using the second communication protocol; and
wherein the first and second multi-mode communication devices are further operable to support direct packet transfers between each other using either the first or a third communication protocol while also supporting communications with the access point.

2. The communication network of claim 1 wherein the first and second multi-mode communication devices are operable to support direct packet transfers between each other using the first communication network protocol.

3. The communication network of claim 1 wherein the first and second multi-mode communication devices are operable to transmit packets directly to each other without using beacon to carry communications of a second communication network protocol using the first communication network protocol.

4. The communication network of claim 1 wherein the first and second multi-mode communication devices are operable to engage in 802.11 protocol BSS communications while engaging in 802.11 direct link communications.

5. The communication network of claim 1 wherein the first and second multi-mode communication devices are operable to communicate directly with each other using the second communication protocol and to subsequently communicate with each other by a direct communication link using the first communication protocol to encapsulate second communication protocol communications.

6. The communication network of claim 1 wherein the first and second multi-mode communication devices are operable to support master-slave communications of a second communication network that operates according to a second communication network protocol while communicating with the access point according to the first communication network protocol.

7. The communication network of claim 1 wherein the first and second multi-mode communication devices are operable determine which of the first and second multi-mode communication devices will operably control communications in the peer-to-peer communication network operating according to the second communication protocol.

8. The communication network of claim 1 wherein the first communication protocol is an 802.11 based protocol for wireless local area networks.

9. The communication network of claim 1 wherein the second communication protocol is a known protocol for personal area networks.

10. A method supporting multi-mode communications in a wireless multi-mode communication device, comprising:
establishing a first communication link with an access point according to a first communication protocol for wireless local area networks;
establishing a second communication link with a remote communication device wherein the second communication link is a peer-to-peer communication link according to a second communication protocol for carrying second communication protocol data intended for a personal area network device according to the second communication protocol; and
subsequently changing the second communication link from the second communication protocol to the first communication protocol wherein the second communication protocol data is encapsulated and transmitted in a direct link according to the first communication protocol.

11. The method of claim 10 wherein the first communication link is a BSS communication link as defined by 802.11 standard communication protocol standards.

12. The method of claim 10 wherein the second communication link is an IBSS communication link as defined by 802.11 standard communication protocol standards.

13. The method of claim 10 wherein the second communication link according to the first communication protocol after changing from the second communication protocol is a direct communication link without beaconing.

14. The method of claim 13 wherein the communication device is operable to support communications over a third communication link according to the second communication protocol while supporting the first and second communication links according to the first communication protocol.

15. A multi-mode hand set communication device operable to control communications in a communication network, comprising:
a baseband processor operable to generate outgoing digital communications and to receive and process ingoing digital communications;
radio front end circuitry operable to communicate according to a personal area network protocol (PAN protocol) as well as a wireless local area network protocol (WLAN protocol);
wherein the handset is operable to:
support the WLAN protocol communications with a remote access point that generates beacons to control wireless local area network communications with compatible communication devices;
support PAN protocol communications with other multi-mode communication devices; and
support direct packet transfers between each the other multi-mode communication devices using either the WLAN protocol or a third communication protocol.

16. The multi-mode hand set communication device of claim 15 wherein the first and second multi-mode communication devices are operable to support direct packet transfers between each other using the WLAN protocol without using beacon to carry communications.

17. The multi-mode hand set communication device of claim 16 wherein the multi-mode hand set communication device is operable to support direct link WLAN protocol transmissions carrying data formed for transmission over the PAN protocol without use of a beacon.

18. The multi-mode hand set communication device of claim 15 wherein the multi-mode hand set communication device is operable to engage in 802.11 protocol BSS communications while engaging in 802.11 direct link communications.

19. The multi-mode hand set communication device of claim 15 wherein the multi-mode hand set communication device is operable to control communications between a remote multi-mode communication device and an associated personal area network device to conduct communications between the personal area network device and the remote multi-mode communication device.
